(19) United States
(12) Patent Application Publication
(10) Pub. No.: US 2020/0296879 A1
(43) Pub. Date: Sep. 24, 2020

(54) SYSTEM, METHOD AND PROGRAM FOR PROVIDING INFORMATION CORRESPONDING TO AGRICULTURAL PRODUCTION PROCESS MANAGEMENT (GAP)

(71) Applicant: OPTIM CORPORATION, Saga (JP)

(72) Inventors: Shunji SUGAYA, Tokyo (JP); Takeshi KYUSAKA, Tokyo (JP)

(21) Appl. No.: 16/608,984

(22) PCT Filed: Apr. 28, 2017
(86) PCT No.: PCT/JP2017/016938

§ 371 Date: Jun. 10, 2020

(51) Int. Cl. A01B 79/00; G06Q 50/02; G02B 27/01; G06K 7/14

(52) U.S. Cl. CPC A01B 79/005; G06Q 50/02; G02B 2027/0178; G06K 7/1417; G02B 27/0172

(57) ABSTRACT

Provided is a system which is able to easily perform pesticide distribution according to the latest criterion. In a GAP corresponding information providing system (1), a control section (10) selects a classification of a cultivated crop by executing a classification selection module (11), and acquires pesticide information related to a pesticide to be distributed by executing a pesticide information acquisition module (12). In this case, the control section (10) executes an extraction module (13) to extract criterion information which is in accordance with the latest criterion corresponding to the classification of the cultivated crop and the pesticide information, and then executes a providing module (14) to provide the extracted criterion information.

### TECHNICAL FIELD

The present disclosure relates to a good agricultural practice (GAP) corresponding information providing system, a GAP corresponding information providing method and a program.

### BACKGROUND

In recent years, good agricultural practice (GAP), taken as appropriate agricultural standards from perspectives such as productivity and food safety in the agricultural field, has been brought into focus. The GAP relates to management standards and practices that producers should follow in respective processes of agricultural product production from various perspectives such as food safety, environmental protection, labor safety and quality improvement.

And, in agricultural operations, it is not convenient to manually make records in a checklist at the scene. A method using either or both of IC tag reading unit and voice input approach is proposed as a method for inputting operation history records, which can easily input check items at the operation scene (for example, reference can be made to patent document 1).

### EXISTING ART DOCUMENT

### Patent Document

[Patent document 1] Japanese Laid-Open Patent Publication No. 2011-86208

### SUMMARY

### Problems to be Solved in the Present Disclosure

Moreover, the GAP also shows benchmarks for the pesticide usage method, but a criterion related to a common basis of GAP is frequently revised. Therefore, it is sought to provide a system that can provide information of a latest criterion in time, and can perform pesticide distribution according to the latest criterion.

The present disclosure has been completed in view of such expectations, and aims to provide a system that can facilitate the pesticide distribution according to the latest criterion.

### Solutions to Problems

The present disclosure provides the following solutions.

A first feature of the present disclosure provides a good agricultural practice (GAP) corresponding information providing system, providing pesticide information corresponding to a criterion related to a common basis of GAP, the GAP corresponding information providing system including: a classification selection module which selects a classification of a cultivated crop; a pesticide information acquisition module, which acquires pesticide information related to a pesticide to be distributed; an extraction module which extracts criterion information in accordance with a latest criterion corresponding to the classification and the pesticide information; and a providing module which provides the criterion information.

According to the first feature of the present disclosure, when the classification selection module selects classification of cultivated crop and the pesticide information acquisition module acquires the pesticide information related to the pesticide to be distributed, the extraction module extracts the criterion information in accordance with the latest criterion corresponding to the classification and the pesticide information; and the providing module provides the extracted criterion information. As a result, agricultural workers can receive information on the latest criterion in time. Therefore, even if they do not confirm whether the criterion has been updated to the latest, they can properly carry out pesticide distribution according to the latest criterion.

A second feature of the present disclosure provides a good agricultural practice (GAP) corresponding information providing system, in the first feature of the present disclosure, the pesticide information acquisition unit reads a two-dimensional code provided on a packaging of the pesticide to acquire the pesticide information.

According to the second feature of the present disclosure, only by reading the two-dimensional code provided on the packaging of the pesticide, the pesticide information related to the pesticide to be distributed is able to be provided to the GAP corresponding information providing system. Therefore, even when the agricultural worker is unfamiliar with the pesticide information and cannot assert whether the criterion has been updated to the latest, he/she also can distribute an appropriate pesticide with an appropriate distribution method according to the latest criterion.

A third feature of the present disclosure provides a good agricultural practice (GAP) corresponding information providing system, in the first feature of the present disclosure, the pesticide information acquisition unit acquires the pesticide information by accepting input of the pesticide information.

According to the third feature of the present disclosure, pesticide information related to the pesticide to be distributed is able to be provided to the GAP corresponding information providing system by inputting pesticide information such as a product name of the pesticide and a name of chemical substance of the pesticide. As a result, agricultural workers can receive information on the latest criterion in time. Therefore, even if they do not confirm whether the criterion has been updated to the latest, they can properly carry out pesticide distribution according to the latest criterion.

A fourth feature of the present disclosure provides a good agricultural practice (GAP) corresponding information providing system, in any one of the first to three features of present disclosure, the extraction unit extracts the criterion information with reference to a website provided by Ministry of Agriculture, Forestry and Fisheries.

According to the fourth feature of the present disclosure, it is unnecessary to update the criterion information one by one. Therefore, even when the agricultural workers cannot assert whether the criterion has been updated to the latest, they also can distribute an appropriate pesticide with an appropriate distribution method according to the latest criterion.

A fifth feature of the present disclosure provides a good agricultural practice (GAP) corresponding information providing system, in any one of the first to three features of present disclosure, the system further includes a criterion storage module, which stores latest information of the criterion in advance, and the extraction module extracts the criterion information with reference to the latest information of the criterion stored in the criterion storage module.

According to the fifth feature of the present disclosure, the latest information of the criterion is stored in the criterion storage module in advance, it is unnecessary to update the criterion information one by one by the agricultural worker. Therefore, even when the agricultural workers cannot assert whether the criterion has been updated to the latest, they also can distribute an appropriate pesticide with an appropriate distribution method according to the latest criterion.

In addition, in a stage of extracting the criterion information by the extraction module, the website provided by the Ministry of Agriculture, Forestry and Fisheries is not referred to. Therefore, even in a case where the farmland is located at a place where a portable terminal is hard to receive radio waves, the GAP corresponding information providing system may appropriately operate.

A sixth feature of the present disclosure provides a good agricultural practice (GAP) corresponding information providing system, in any one of the first to five features of present disclosure, the criterion information includes more than one type of information selected from food safety, environmental protection, labor safety, and GAP.

According to the sixth feature of the present disclosure, the agricultural worker, in selecting more than one perspectives of food safety, environmental protection, and labor safety and GAP, even without confirming whether the criterion has been updated to the latest, can appropriately perform pesticide distribution according to the latest criterion.

A seventh feature of the present disclosure provides a good agricultural practice (GAP) corresponding information providing system, in any one of the first to sixth features of present disclosure, the pesticide information acquisition module acquires pesticide information by analyzing an image of the pesticide captured by smart glasses worn by a user; and the providing module provides criterion information by displaying the criterion information corresponding to the pesticide seen through a display panel of the smart glasses on the display panel of the smart glasses.

According to the seventh feature of the present disclosure, the pesticide information can be provided by the image taken by the smart glasses. Here, the smart glasses are used as the terminal, so there is no need to move the terminal by holding in hands. The result is to provide a system highly convenient for the user whose hands are apt to be occupied by working tools in agricultural operations.

### Beneficial Effects

According to the present disclosure, a system is provided, which can provide information on the latest criterion in time for agricultural workers so that they can properly carry out pesticide distribution according to the latest criterion even if they do not confirm whether the criterion has been updated to the latest one by one.

### BRIEF DESCRIPTION OF DRAWINGS

FIG. 1 is a block diagram illustrating hardware composition and software functions of a GAP corresponding information providing system 1 according to an embodiment;

FIG. 2 is a flowchart of a GAP corresponding information providing method according to an embodiment;

FIG. 3 is an example of a classification database 31 according to an embodiment;

FIG. 4 is an example of a criterion information database 32 according to an embodiment;

FIG. 5 is an example of information of small classifications subdivided based on FIG. 4; and

FIG. 6 is a display example of an image display section 60 according to an embodiment.

### DETAILED DESCRIPTION

Hereinafter, implementations of the present disclosure will be described with reference to the drawings. It is to be noted that description hereinafter is only exemplary and the technical scope of the present invention is not so limited.

<Composition of a GAP Corresponding Information Providing System 1>

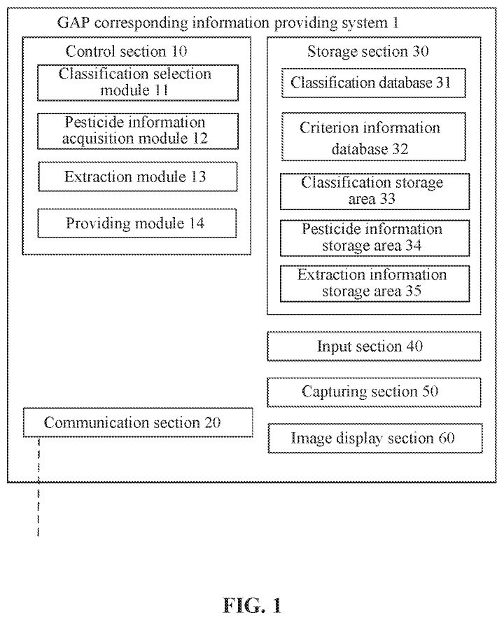

FIG. 1 is a block diagram illustrating hardware composition and software functions of a GAP corresponding information providing system 1 according to an embodiment.

The GAP corresponding information providing system 1 has: a control section 10 which controls data; a communication section 20 which communicates with other devices; a storage section 30 which stores data; an input section 40 which accepts user operations; a capturing section 50 which acquires pesticide information; and an image display section 60 which outputs the data controlled by the control section 10 and displays images.

The GAP corresponding information providing system 1 may be a stand-alone system integrated with a portable terminal such as a smart phone, smart glasses, or a smart watch, or may be a cloud-type system including a portable terminal and a server connected to the portable terminal via a network. In the embodiment, for ease of description, it is described based on a case that the GAP corresponding information providing system 1 is a stand-alone system.

Optionally, the GAP corresponding information providing system 1 is a wearable terminal representative by smart glasses, a headset terminal and a smart watch. As a result, users such as agricultural workers do not need to move the terminal by holding in hands, thereby providing a highly convenient GAP corresponding information providing system 1 for the users whose hands are apt to be occupied by working tools.

Optionally, in a case where the GAP corresponding information providing system 1 is a smart phone, the GAP corresponding information providing system 1 is configured as a wearable terminal, thus the smart phone is worn on the body and both hands are free.

The control section 10 includes a central processing unit (CPU), a random access memory (RAM), a read only memory (ROM) and the like.

The communication section 20 is a device capable of communicating with other devices, such as a corresponding device having Wireless Fidelity (Wi-Fi) according to IEEE802.11.

The control section 10 reads a prescribed program and works in cooperation with the communication section 20 as needed to implement a classification selection module 11, a pesticide information acquisition module 12, an extraction module 13, and a providing module 14.

The storage section 30 is a device that stores data and files, and includes a data storage section implemented by a hard disk, a semiconductor memory, a recording medium, a memory card, and the like. The storage section 30 stores a classification database 31, a criterion information database 32, a classification storage area 33, a pesticide information storage area 34, and an extraction information storage area 35, which will be described hereinafter. The storage section 30 further stores data of images displayed on the image display section 60.

The type of the input section 40 is not particularly limited. Examples of the input section 40 include a keyboard, a mouse, a touch panel and the like.

The capturing section 50 functions as a reading unit reading a two-dimensional code on a packaging of a pesticide, a capturing unit capturing an image of the pesticide and the like. The capturing section 50 converts (captures) an optical image acquired via a lens into an image signal through a capturing element such as a charge coupled device (CCD) or a complementary metal oxide semiconductor (CMOS).

The type of the image display section 60 is not particularly limited. Examples of the image display section 60 include a displayer, a touch panel and the like.

<A Flowchart of a GAP Corresponding Information Providing Method Using the GAP Corresponding Information Providing System 1>

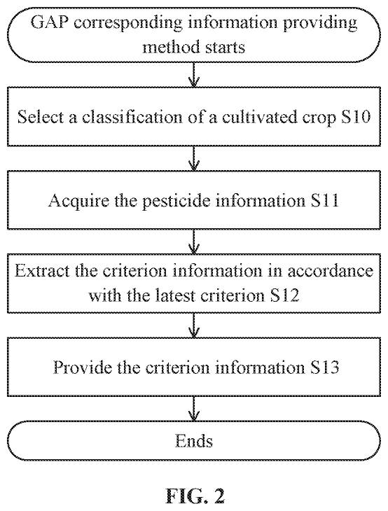

FIG. 2 illustrates a flowchart of a GAP corresponding information providing method using the GAP corresponding information providing system 1. Processes performed by respective above-mentioned hardware and software modules are described.

(In step S10, classification of a cultivated crop is selected.)

First, the control section 10 of the GAP corresponding information providing system 1 executes the classification selection module 11 and selects a classification of a cultivated crop (step S10).

First, the control section 10 refers to the classification database 31 stored in the storage section 30 in advance.

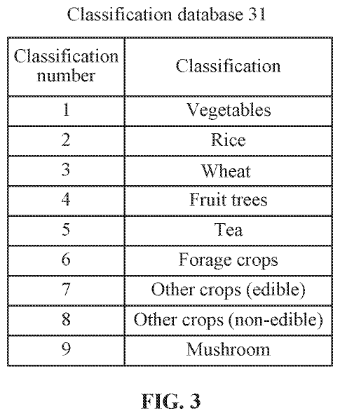

FIG. 3 shows schematic constitution of the classification database 31. By April 2017, a criterion related to a common basis of GAP is divided into nine classifications: vegetables, rice, wheat, fruit trees, tea, forage crops, other crops (edible), other crops (non-edible) and mushroom. Therefore, in the classification database 31, these nine classifications are stored corresponding to classification numbers.

The control section 10 reads the classification database 31 and displays the classifications stored in the classification database 31 on the image display section 60 to prompt the user (mainly refers to an agricultural worker) to select which classification the cultivated crop belongs to. Then, the control section 10 stores the result of the selection of the user in the classification storage area 33.

(In step 11, pesticide information is acquired.)

Next, the control section 10 executes a pesticide information acquisition module 12 to acquire pesticide information related to a pesticide to be distributed (step S11).

An approach for acquiring the pesticide information is not particularly limited. For example, the control section 10 may acquire the pesticide information by reading record information such as a barcode and a two-dimensional code provided on the packaging of the pesticide through the capturing section 50, or may acquire the pesticide information by accepting input of the pesticide information through an operation of the input section 40.

In a case of reading the record information attached onto the packaging of the pesticide, the pesticide information related to the pesticide to be distributed may be provided to the GAP corresponding information providing system 1 only by the control section 10 reading the two-dimensional code provided on the packaging of the pesticide via the capturing section 50. Therefore, even when the agricultural worker is unfamiliar with the pesticide information and cannot assert whether the criterion has been updated to the latest, he/she also can distribute an appropriate pesticide with an appropriate distribution method according to the latest criterion.

In a case of acquiring the pesticide information by accepting input of the pesticide information through the operation of the input section 40, the user is able to provide the pesticide information related to the pesticide to be distributed to the GAP corresponding information providing system 1 by inputting the pesticide information such as a product name of the pesticide and a name of chemical substance of the pesticide. As a result, the agricultural worker can receive information on the latest criterion in time. Therefore, even if he/she do not confirm whether the criterion has been updated to the latest, he/she can properly carry out pesticide distribution according to the latest criterion.

Alternatively, the pesticide information acquisition module 12 may act as a module for acquiring the pesticide information by analyzing an image of the pesticide captured by smart glasses worn by the user. In this case, in the process of step S13 described below, the pesticide information is able to be provided by using the image captured by the smart glasses. In this case, the smart glasses are used as the terminal, so there is no need to move the terminal by holding in hands. The result is to provide a system which is highly convenient for the user whose hands are apt to be occupied by working tools in agricultural operations.

It is to be noted that the pesticide information acquired by the control section 10 may be stored in the pesticide information storage area 34 of the storage section 30.

(In step S12, criterion information is extracted.)

Next, the control section 10 executes the extraction module 13 to extract criterion information, where the criterion information is in accordance with a latest criterion corresponding to the classification selected in the step S10 and the pesticide information acquired in the step S11 (step S12).

An approach for extracting the criterion is not particularly limited. As an example, the control section 10 is able to extract the criterion information with reference to the website of Ministry of Agriculture, Forestry and Fisheries (http://www.maff.go.jp/j/seisan/gizyutu/gap/guideline/).

According to the approach, it is unnecessary to update the criterion information one by one. Therefore, even when the agricultural worker cannot assert whether the criterion has been updated to the latest, he/she also can distribute an appropriate pesticide with an appropriate distribution method according to the latest criterion.

As another example, the control section 10 reads latest information of the criterion which is stored in the storage section 30 in advance as the criterion information database 32, and extracts the criterion information with reference to the latest information of the criterion stored in the criterion information database 32.

According to the approach, the latest information of the criterion is stored in the storage section 30 in advance, it is unnecessary to update the criterion information one by one by the agricultural worker. Therefore, even when the agricultural worker cannot assert whether the criterion has been updated to the latest, he/she also can distribute an appropriate pesticide with an appropriate distribution method according to the latest criterion.

In addition, in a stage of extracting the criterion information by the control section 10, the website provided by the Ministry of Agriculture, Forestry and Fisheries is not referred to. Therefore, even in a case where the farmland is located at a place where a portable terminal is hard to receive radio waves, the GAP corresponding information providing system 1 may appropriately operate.

Hereinafter, for the another example described above, i.e., the case where the criterion is stored in the storage unit 30 as the criterion information database 32 in advance will be described.

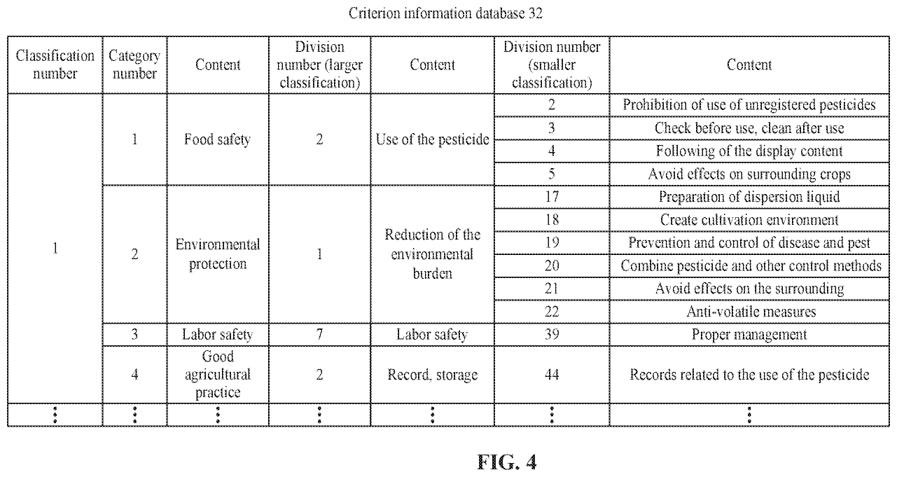

FIG. 4 shows schematic constitution of the criterion information database 32. The criterion information database 32 is at least updated by the control section 10 through information acquired by a communication section 20 from an external website whenever the criterion related to the common basis of GAP and information of the website referred by the criterion are updated.

The criterion information database 32 is configured to include, for each classification of cultivated crop, at least one type of the following information: information related to a category of setting food safety as the main purpose, information related to a category of setting environmental protection as the main purpose, information related to a category of setting labor safety as the main purpose; and information related to all categories of GAP.

Divisions (larger classifications) are made according to various purposes and these divisions (larger classifications) may be further divided into divisions (smaller classifications). In FIG. 4, the classifications related to the pesticide are shown, but it is not limited to this scheme, information on classifications different from the pesticide, such as a fertilizer application method may also be stored.

For example, in a case where a classification selected by step S10 is “vegetables” with the classification number “1”, the control section 10 reads the criterion information database 32 and information associated with the classification number “1” is respectively referred to in an order of division numbers (small classifications).

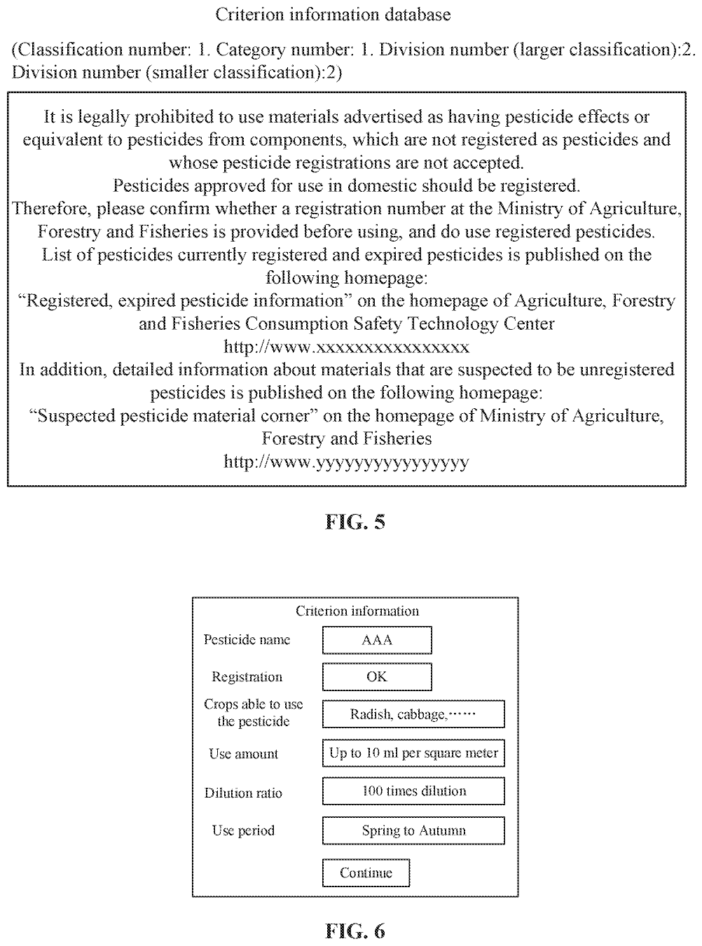

FIG. 5 is information stored in the storage section 30 in advance as “prohibition of use of unregistered pesticides” under a division number (a smaller classification) “2”. According to this information, information of unregistered pesticides is posted on “registered, expired pesticide information” on the homepage of Agriculture, Forestry and Fisheries Consumption Safety Technology Center and “suspected pesticide material corner” on the homepage of Ministry of Agriculture, Forestry and Fisheries.

Therefore, the control section 10 may determine whether the pesticide acquired in the step S11 is an unregistered pesticide with reference to these homepages. Alternatively, information of these homepages may be stored in the storage section 30 in advance, and the control section 10 determines with reference to the stored information. The former case has the following advantages: suppressing an update frequency of the criterion information database 32. The latter case has the advantage that even in a case where the farmland is located at a place where a portable terminal is hard to receive radio waves, the GAP corresponding information providing system 1 may appropriately operate.

Thereafter, the control section 10 also extracts the criterion information of other numbers of divisions (small classifications). Then, the extracted criterion information is stored in the extraction information storage area 35 of the storage section 30.

(In step S13, the criterion information is provided.)

Next, the control section 10 executes the providing module 14 and displays the criterion information stored in the extraction information storage section 35 in the step S12 on the image display section 60 (step S13).

FIG. 6 is an example of a display image on the image display section 60. Information such as information of the pesticide name, information indicating whether the pesticide is a registered pesticide, types of crops that are able to use the pesticide, a usage amount of the pesticide, a dilution ratio of the pesticide and usage period of the pesticide is displayed from an upper part of the image display section 60. The information is the reference obtained from criterion related to the common basis of GAP and information on the website referred by the criterion, and is equivalent to information which is consistent with information of the pesticide the user (agricultural worker) considers using.

According to the embodiments of the present disclosure, the control section 10 selects the classification of the cultivated crop by executing the classification selection module 11, and acquires the pesticide information related to the pesticide to be distributed by executing the pesticide information acquisition module 12. In this case, the control section 10 executes the extraction module 13 to extract the criterion information which is in accordance with a latest criterion corresponding to the classification of the cultivated crop and the pesticide information, and then executes the providing module 14 to provide the extracted criterion information. As a result, agricultural workers can receive information on the latest criterion in time. Therefore, even if they do not confirm whether the criterion has been updated to the latest, they can properly carry out pesticide distribution according to the latest criterion.

In addition, according to the embodiments of the disclosure, optionally, the pesticide information acquisition module 12 is a module acquiring the pesticide information by reading a two-dimensional code provided on the packaging of the pesticide through the imaging section 50. Therefore, only by reading the two-dimensional code provided on the packaging of the pesticide, the pesticide information related to the pesticide to be distributed is able to be provided to the GAP corresponding information providing system 1. Therefore, even when the agricultural worker is unfamiliar with the pesticide information and cannot assert whether the criterion has been updated to the latest, he/she also can distribute an appropriate pesticide with an appropriate distribution method according to the latest criterion.

In addition, according to the embodiments of the disclosure, the pesticide information acquisition module may be configured to acquire pesticide information by accepting the input of pesticide information through the input section 40. In this case, the pesticide information related to the pesticide to be distributed is able to be provided to the GAP corresponding information providing system 1 by inputting pesticide information such as a product name of the pesticide and a name of chemical substance of the pesticide through the input section 40. As a result, agricultural workers can receive information on the latest criterion in time. Therefore, even if they do not confirm whether the criterion has been updated to the latest, they can properly carry out pesticide distribution according to the latest criterion.

In addition, according to the embodiments of the disclosure, the extraction module may be a module extracting the criterion information with reference to a website provided by the Ministry of Agriculture, Forestry and Fisheries. Thus it is unnecessary to update the criterion information one by one. Therefore, even when the agricultural workers cannot assert whether the criterion has been updated to the latest, they also can distribute an appropriate pesticide with an appropriate distribution method according to the latest criterion.

In addition, according to the embodiments of the disclosure, optionally, the latest information of the criterion is stored in the storage section 30 in advance as the criterion information database 32, and the control section 10 executes the extraction module 13 and extracts the criterion information with reference to the latest information of the criterion stored in the criterion storage database 32.

Thus the latest information of the criterion is stored in the storage section 30 in advance as the criterion information database 32, it is unnecessary to update the criterion information one by one by the agricultural worker. Therefore, even when the agricultural worker cannot assert whether the criterion has been updated to the latest, he/she also can distribute an appropriate pesticide with an appropriate distribution method according to the latest criterion.

In addition, in a stage of executing the extraction module 13 by the control section 10, the control section 10 does not refer to the website provided by the Ministry of Agriculture, Forestry and Fisheries. Therefore, even in a case where the farmland is located at a place where a portable terminal is hard to receive radio waves, the GAP corresponding information providing system 1 may appropriately operate.

In addition, according to the embodiments of the disclosure, optionally, the pesticide information acquisition module 12 is a module acquiring the pesticide information by analyzing an image of the pesticide captured by smart glasses worn by the user, and the providing module 14 is a module providing criterion information by displaying the criterion information corresponding to the pesticide seen through a display panel of the smart glasses on the display panel of the smart glasses.

Thus the pesticide information is able to be provided by images captured by the smart glasses. Here, the smart glasses are used as the terminal, so there is no need to move the terminal by holding in hands. The result is to provide the GAP corresponding information providing system 1 which is highly convenient for the user whose hands are apt to be occupied by working tools in agricultural operations.

The above methods and functions are implemented by a computer (including a CPU, an information processing device and various terminals) through reading and executing the prescribed program. The program is provided by being recorded on a computer-readable recording medium such as a floppy disk, a compact disc (CD, including a CD-ROM, etc.) and a high-density digital video disc (DVD, including a DVD-ROM and a DVD-RAM, etc.). In this case, the computer reads the program from the recording medium, transfers the program to an internal storage device or an external storage device, stores and executes the program. In addition, the program may be recorded in a storage device (recording medium) such as a magnetic disk, an optical disk, or a magneto-optical disk in advance, and provided from the storage device to a computer via a communication link.

As mentioned above, the embodiments of the present disclosure are described, but the present disclosure is not limited to these embodiments. Moreover, the effects described in the embodiments of the present disclosure are merely a list of the most suitable effects produced by the present disclosure, and the effects of the present disclosure are not limited to the effects described in the embodiments of the present disclosure.

### REFERENCE SIGNS DESCRIPTION

1 GAP corresponding information providing system
10 control section
11 classification selection module
12 pesticide information acquisition module
13 extraction module
14 providing module
20 communication section
30 storage section
31 classification database
32 criterion information database
33 classification storage area
34 pesticide information storage area
35 extraction information storage area
40 input section
50 capturing section
60 image display section

1. A good agricultural practice (GAP) corresponding information providing system, providing pesticide information corresponding to a criterion related to a common basis of GAP, the GAP corresponding information providing system comprising:
a classification selection module, which selects a classification of a cultivated crop;
a pesticide information acquisition module, which acquires pesticide information related to a pesticide to be distributed by analyzing an image of the pesticide captured by smart glasses worn by the user;
an extraction module, which extracts criterion information, wherein the criterion information is in accordance with a latest criterion corresponding to the classification and the pesticide information;
a providing module, which provides the criterion information by displaying the criterion information corresponding to the pesticide seen through a display panel of the smart glasses on the display panel of the smart glasses; and
a criterion storage module, which stores latest information of the criterion in advance;
wherein the extraction module extracts the criterion information with reference to the latest information of the criterion stored in the criterion storage module.

2. The GAP corresponding information providing system of claim 1, wherein the pesticide information acquisition module reads a two-dimensional code provided on a packaging of the pesticide to acquire the pesticide information.

3. The GAP corresponding information providing system of claim 1, wherein the pesticide information acquisition module acquires the pesticide information by accepting input of the pesticide information.

4. The GAP corresponding information providing system of claim 1, wherein the extraction module extracts the criterion information with reference to a website provided by Ministry of Agriculture, Forestry and Fisheries.

5. (canceled)

6. The GAP corresponding information providing system of claim 1, wherein the criterion information comprises more than one type of information selected from food safety, environmental protection, labor safety, and GAP.

7. (canceled)

8. A good agricultural practice (GAP) corresponding information providing method, executed by a GAP corresponding information providing system providing pesticide information corresponding to a criterion related to a common basis of GAP, comprising:
selecting a classification of a cultivated crop;
acquiring pesticide information related to a pesticide to be distributed by analyzing an image of the pesticide captured by smart glasses worn by a user;
a criterion storage step of storing latest information of criterion in advance; wherein criterion information is in accordance with a latest criterion corresponding to the pesticide information;
extracting the criterion information with reference to the latest information of the criterion stored in the criterion storage step; and
providing the criterion information by displaying the criterion information corresponding to the pesticide seen through a display panel of the smart glasses on the display panel of the smart glasses.

9. A computer-readable program, which is used for enabling a good agricultural practice (GAP) corresponding information providing system providing pesticide information corresponding to a criterion related to a common basis of GAP to perform:
selecting a classification of a cultivated crop;
acquiring pesticide information related to a pesticide to be distributed by analyzing an image of the pesticide captured by smart glasses worn by a user;
a criterion storage step of storing latest information of criterion in advance; wherein criterion information is in accordance with a latest criterion corresponding to the pesticide information;
extracting the criterion information with reference to the latest information of the criterion stored in the criterion storage step; and
providing the criterion information by displaying the criterion information corresponding to the pesticide seen through a display panel of the smart glasses on the display panel of the smart glasses.
